(19) United States
(12) Patent Application Publication
(10) Pub. No.: US 2025/0070424 A1
(43) Pub. Date: Feb. 27, 2025

(54) BATTERY

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Satoshi FUJIMURA, Toki-shi (JP); Yuki SATO, Toyota-shi (JP); Yozo UCHIDA, Toyota-shi (JP); Nozomi TATEYAMA, Okazaki-shi (JP); Masahiro UCHIMURA, Miyoshi-shi (JP); Masataka ASAI, Toyota-shi (JP); Shigeru MATSUMOTO, Toyohashi-shi (JP); Takashi TAKIMOTO, Kosai-shi (JP); Shunsuke NAKAMURA, Hamamatsu-shi (JP); Keitaro MACHIDA, Hamamatsu-shi (JP)

(21) Appl. No.: 18/617,697

(22) Filed: Mar. 27, 2024

(30) Foreign Application Priority Data
Aug. 25, 2023 (JP) 2023-137066

(51) Int. Cl. H01M 50/567; H01M 50/55; H01M 50/557

(52) U.S. Cl. CPC H01M 50/567; H01M 50/55; H01M 50/557

(57) ABSTRACT

In a battery, a lid member of a battery case is provided with a terminal part and a resin member. The terminal part has a terminal plate-shaped portion located inside the battery case, which extends wider than a through hole along an inner surface of the lid member. The resin member has an inner resin plate-shaped portion located between the inner surface of the lid member and the terminal plate-shaped portion. The lid member, on the inner surface side around the through hole, includes a protruding portion defined by a protruding inner surface joined to the inner resin plate-shaped portion and protruding toward the inside of the battery case relative to a non-protruding inner surface farther from the through hole than the protruding inner surface. Side surfaces of the protruding portion and the terminal plate-shaped portion do not project outward beyond a side surface of the inner resin plate-shaped portion.

### CROSS-REFERENCE TO RELATED APPLICATIONS

This application is based upon and claims the benefit of priority to Japanese Patent Application No. 2023-137066 filed on Aug. 25, 2023, the entire contents of which are incorporated herein by reference.

### BACKGROUND

### Technical field

The disclosure relates to a battery having a battery case and a terminal part.

### Related Art

A terminal part of a battery is partially exposed to the front side, i.e., outside, of a battery case. The terminal part is connected, on an opposite side from the exposed side, to electrode plates provided in the battery case. That is, the terminal part is provided extending to the inside and outside of the battery case. Such a terminal part may be joined to the battery case at a through hole formed in the battery case via a resin member, as disclosed in for example Japanese unexamined patent application publication No. 2021-086813 (2021-086813A). This publication 2021-086813A describes a battery sealed with a resin member that fills the gap between the battery case and the terminal part while insulating between them.

### SUMMARY

### Technical Problems

The above-described resin member is made of a material different from the battery case and the terminal part. Thus, the linear expansion coefficient of the resin member is different from those of the battery case and the terminal part. Accordingly, when the temperature of the battery changes, tensile stress may occur in the resin member near a joining boundary of the resin member with respect to a joining member, such as the battery case or terminal part. Depending on the magnitude and frequency of the action of the tensile stress, the resin member may be damaged. Further, depending on the extent of damage to the resin member, some defects, such as a degradation of the sealing property of the battery, may be caused.

The present disclosure has been made to address the above problems and has a purpose to provide a battery configured to suppress damage to a resin member joined to a battery case and a terminal part from being damaged.

### Means of Solving the Problems

To solve the above problems, one aspect of the disclosure provides a battery comprising: a battery case formed with a through hole; a terminal part provided extending through the through hole to inside and outside of the battery case; and a resin member provided between and joined to the battery case and the terminal part, wherein the terminal part includes a columnar portion, at least a part of which is located in the through hole, and a terminal plate-shaped portion that is located in the battery case and has a shape extending more widely than the through hole along an inner surface of the battery case, the resin member includes a tube-shaped portion located between a wall surface of the through hole and the columnar portion of the terminal part, and a resin plate-shaped portion located between the inner surface of the battery case and the terminal plate-shaped portion, the battery case includes a protruding portion, on the inner surface along a circumferential edge of the through hole, the protruding portion including a joining inner surface that is joined to the resin plate-shaped portion and located protruding toward the inside of the battery case as compared with a portion of the inner surface, that is farther from the through hole than the joining inner surface, and the protruding portion and the terminal plate-shaped portion each have a side surface that does not project outward beyond a side surface of the resin plate-shaped portion.

When the battery case, terminal part, and resin member of the battery configured as above expand or contract due to temperature changes, this battery can suppress the stress acting on the resin member due to differences in the degree of expansion/contraction between the resin member and the other members. Thus, the resin member is less likely to be damaged.

According to the disclosure, a battery is provided with a resin member joined to a battery case and a terminal part, which is less likely to be damaged.

### BRIEF DESCRIPTION OF THE DRAWINGS

FIG. 1 is a perspective view of a battery in an embodiment;

FIG. 2 is a cross-sectional view showing a configuration of part of the battery including an outer terminal in the embodiment;

FIG. 3 is a diagram showing an analytical model of a resin member joined to a metal member;

FIG. 4 is a diagram showing stress distribution obtained from stress analysis using the analytical model; and

FIG. 5 is a cross-sectional view showing a variant of the configuration of part of the battery including the outer terminal.

### DETAILED DESCRIPTION OF THE EXEMPLARY EMBODIMENTS

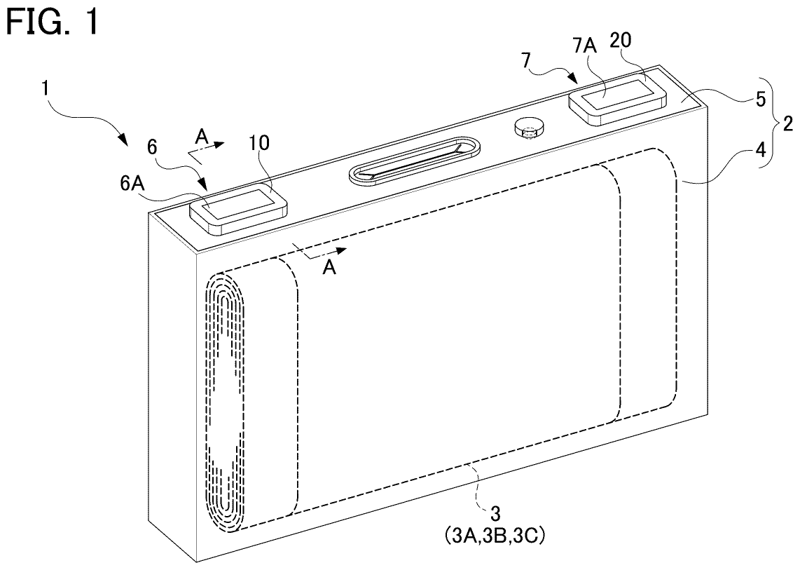

A detailed description of a battery 1 shown in FIG. 1, which is an embodiment of this disclosure, will now be given referring to the accompanying drawings. The battery 1 includes a battery case 2 and an electrode body 3 housed therein. The electrode body 3 is constituted of positive electrode plates 3A and negative electrode plates 3B, which are stacked alternately with separators 3C interposed therebetween. The battery case 2 further contains an electrolyte in addition to the electrode body 3.

Further, the battery case 2 has a casing 4 and a lid member 5. In this lid member 5, a positive outer terminal 6 and a negative outer terminal 7 are provided. As viewed from outside of the battery 1, at the places for the outer terminals 6 and 7, terminal surfaces 6A and 7A and resin members 10 and 20 respectively appear. The outer terminal 6 is a positive electrode terminal and the outer terminal 7 is a negative electrode terminal.

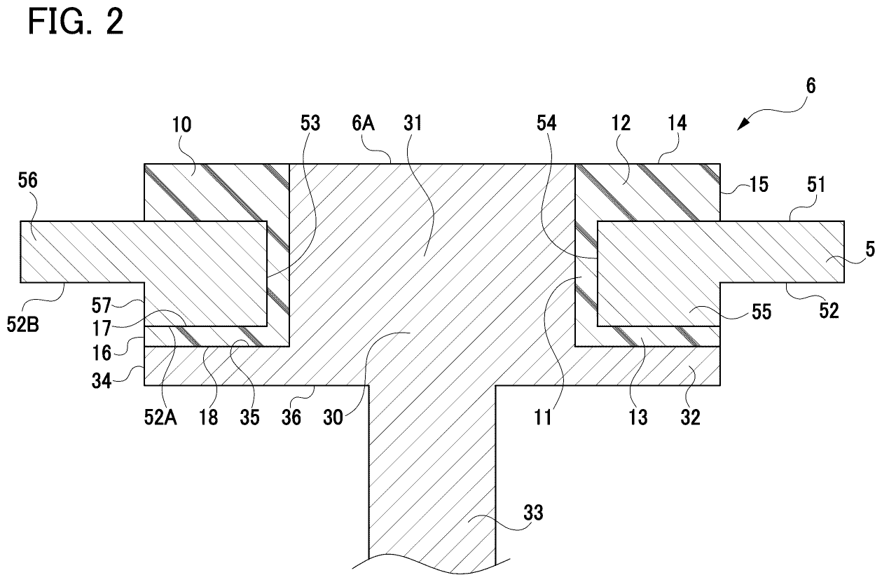

The configuration of part of the battery 1 including the outer terminal 6 is described below referring to FIG. 2. FIG. 2 is a cross-sectional view along a line A-A in FIG. 1. As the part of the battery 1 including the outer terminal 6, a terminal part 30 is provided as shown in FIG. 2. The terminal part 30 is provided extending to the front side, which is the upper side in FIG. 2 above an outer surface 51 of the lid member 5, and the back side, which is the lower side in FIG. 2 below the inner surface 52 of the lid member 5. In FIG. 2, the lower side below the inner surface 52 of the lid member 5 corresponds to the inside of the battery case 2. Thus, the terminal part 30 is provided extending to the inside and outside of the battery case 2. Further, the resin member 10 is provided between the lid member 5 and the terminal part 30.

The lid member 5 is made of conductive metal; specifically, in the present embodiment, the lid member 5 is made of aluminum. The lid member 5 is formed with a through hole 53 at the place for the outer terminal 6, through which the terminal part 30 extends. In FIG. 2, the through hole 53 is defined by a wall surface 54. The lid member 5 includes a protruding portion 55 formed along the circumferential edge of the through hole 53, inside of the battery case 2, i.e., on the inner surface 52 side.

The protruding portion 55 is a part of the lid member 5, which protrudes toward the inside of the battery case 2 as compared with a portion of the lid member 5, that is farther from the through hole 53 than the protruding portion 55. This portion farther from the through hole 53 than the protruding portion 55 is indicated as a non-protruding portion 56 in FIG. 2. Of the inner surface 52, a part corresponding to the protruding portion 55 is indicated as a protruding inner surface 52A and a part corresponding to the non-protruding portion 56 is indicated as a non-protruding inner surface 52B. In the present embodiment, the protruding inner surface 52A is the end face of the protruding portion 55 in its protruding direction.

The protruding inner surface 52A is located protruding toward the inside of the battery case 2 more than the non-protruding inner surface 52B. In other words, the inner surface 52 of the lid member 5 has a step (i.e., a height difference) formed between the protruding portion 55 and the non-protruding portion 56. In FIG. 2, the protruding portion 55 has a side surface (i.e., a peripheral surface) 57 located forming the step. This side surface 57 connects the protruding inner surface 52A and the non-protruding inner surface 52B. An opening of the through hole 53 on the inside of the battery case 2 is located on the protruding inner surface 52A. Specifically, the through hole 53 is provided within a region of the lid member 5, surrounded by the side surface 57 of the protruding portion 55.

The terminal part 30 is made of conductive metal; specifically, in the present embodiment, the terminal part 30 is made of aluminum. The terminal part 30 includes a columnar portion 31, a terminal plate-shaped portion 32, and a current collecting portion 33. The columnar portion 31 extends through the inside of the through hole 53 and is exposed, on its one end, to the outside of the battery case 2. The exposed surface of the columnar portion 31 is a terminal surface 6A. At least a part of the columnar portion 31 is located inside the through hole 53.

The terminal plate-shaped portion 32 is located more inside the battery case 2 than the columnar portion 31. The terminal plate-shaped portion 32 is continuous to the columnar portion 31. The terminal plate-shaped portion 32 has a shape extended outwardly more than the columnar portion 31 along the protruding inner surface 52A inside the battery case 2. Further the terminal plate-shaped portion 32 in the embodiment is extended outwardly larger than the through hole 53. In FIG. 2, the terminal plate-shaped portion 32 has a side surface (i.e., a peripheral surface) 34, a first principal surface 35, and a second principal surface 36. The first principal surface 35 of the terminal plate-shaped portion 32 faces the inner surface 52 of the lid member 5. The second principal surface 36 of the terminal plate-shaped portion 32 is the back surface opposite the first principal surface 35 of the terminal plate-shaped portion 32.

The current collecting portion 33 is provided extending more inside the battery case 2 than the terminal plate-shaped portion 32. This current collecting portion 33 is continuous, on its one end, to the terminal plate-shaped portion 32. The current collecting portion 33 is connected to the positive electrode plates 3A of the electrode body 3, on the opposite side to the one end continuous to the terminal plate-shaped portion 32. The current collecting portion 33 in the embodiment is thinner than the terminal plate-shaped portion 32 as shown in FIG. 2.

The resin member 10 is made of resin with insulating properties. In the embodiment, this resin is a composite resin made of base resin mixed with filler. Resins available as the base resin may include, for example, polyphenylene sulfide resin (PPS), polyarylene sulfide (PAS), and so on. Fillers available as the filler mixed in the base resin may include, for example, glass, alumina, potassium titanate, and so on. In the embodiment, PPS resin is used as the base resin and glass is used as the filler. The resin member 10 in the embodiment, made of the base resin mixed with the filler, has higher mechanical strength than a resin member containing no filler.

The resin member 10 includes a tube-shaped portion 11, an outer resin plate-shaped portion 12, and an inner resin plate-shaped portion 13. The tube-shaped portion 11 is located between the wall surface 54 of the through hole 53 and the columnar portion 31. The outer resin plate-shaped portion 12 is provided more outside the battery case 2 than the tube-shaped portion 11. The outer resin plate-shaped portion 12 is continuous to the tube-shaped portion 11. The outer resin plate-shaped portion 12 is exposed to the outside on the outer surface 51 of the lid member 5. Specifically, the outer resin plate-shaped portion 12 has an upper surface 14 and a side surface (i.e., a peripheral surface) 15 that are exposed outside the battery case 2.

The inner resin plate-shaped portion 13 is provided more inside the battery case 2 than the tube-shaped portion 11. The inner resin plate-shaped portion 13 is continuous to the tube-shaped portion 11. The inner resin plate-shaped portion 13 is extended more largely than the through hole 53 inside the battery case 2. In FIG. 2, the inner resin plate-shaped portion 13 has a side surface (i.e., a peripheral surface) 16, a first principal surface 17, and a second principal surface 18. The first principal surface 17 of the inner resin plate-shaped portion 13 faces the inner surface 52 of the lid member 5. The second principal surface 18 of the inner resin plate-shaped portion 13 is the back surface opposite the first principal surface 17. Further, the second principal surface 18 of the inner resin plate-shaped portion 13 faces the first principal surface 35 of the terminal plate-shaped portion 32. The inner resin plate-shaped portion 13 is located between the protruding inner surface 52A as part of the inner surface 52 of the lid member 5 and the terminal plate-shaped portion 32.

The resin member 10 is made by injecting molten resin between the lid member 5 and the terminal part 30 held in predetermined positional relationship, and solidifying the molten resin. In other words, the lid member 5, resin member 10, and terminal part 30 are integrally formed together by insert molding. The resin member 10 is thus joined to both the lid member 5 and the terminal part 30.

Specifically, the inner resin plate-shaped portion 13 is joined to the protruding portion 55 of the lid member 5 and the terminal plate-shaped portion 32 of the terminal part 30. To be concrete, the first principal surface 17 of the inner resin plate-shaped portion 13 is joined to the protruding inner surface 52A of the protruding portion 55 of the lid member 5. Accordingly, the protruding inner surface 52A is the joining inner surface as part of the inner surface 52, which is bonded to the inner resin plate-shaped portion 13 of the resin member 10. The second principal surface 18 is joined to the first principal surface 35 of the terminal plate-shaped portion 32 of the terminal part 30. That is, the inner resin plate-shaped portion 13 is sandwiched between and joined to metal parts having a different linear expansion coefficient from that of the inner resin plate-shaped portion 13. In the embodiment, both the side surface 57 of the protruding portion 55 of the lid member 5 and the side surface 34 of the terminal plate-shaped portion 32 of the terminal part 30 are configured not to project outward beyond the side surface 16 of the inner resin plate-shaped portion 13. The respective shapes of the lid member 5, the resin member 10, and the terminal part 30, at the location for the outer terminal 6, are generally the same as in FIG. 2, even in any cross-section location different from in FIG. 2 as long as the cross-section is parallel to the central axis of the through hole 53.

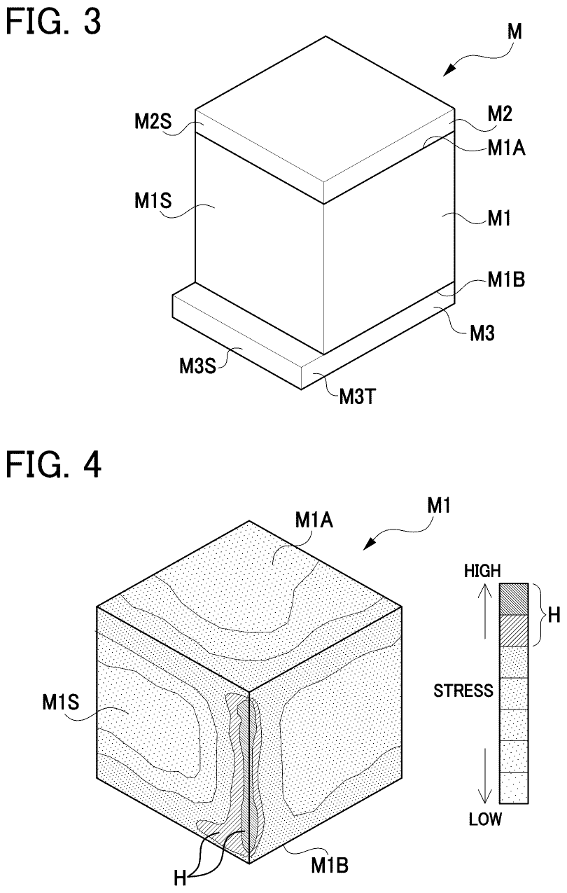

FIG. 3 shows an analysis model M that consists of two metal plates or pieces and a resin plate or piece sandwiched therebetween. This analysis model M is formed by three layers; a middle layer model M1, a first surface layer model M2, and a second surface layer model M3. The first surface layer model M2 is joined to the first principal surface M1A of the middle layer model M1. The second surface layer model M3 is joined to the second principal surface M1B of the middle layer model M1. The second principal surface M1B is the back surface opposite the first principal surface M1A. The parameters of the middle layer model M1 are set similar to those of a combination of PPS resin as base resin and glass as filler. In other words, the parameters of the middle layer model M1 are similar values to those of the resin member 10. Further, the parameters of the first surface layer model M2 and the second surface layer model M3 are set similar to those of aluminum. In other words, the parameters of the first surface layer model M2 and the second surface layer model M3 are similar values to those of the lid member 5 and the terminal part 30. That is, the analysis model M is an object imitating the inner resin plate-shaped portion 13 of the resin member 10 whose front and back sides are joined to the protruding portion 55 of the lid member 5 and the terminal plate-shaped portion 32 of the terminal part 30, respectively.

In FIG. 3, the middle layer model MI has a side surface (i.e., a peripheral surface) M1S, the first surface layer model M2 has a side surface (i.e., a peripheral surface) M2S, and the second surface layer model M3 has a side surface (i.e., a peripheral surface) M3S. The side surface M2S of the first surface layer model M2 is flush with the side surface MIS of the middle layer model M1. In contrast, the side surface M3S of the second surface layer model M3 projects outward beyond the side surface MIS of the middle layer model M1. The second surface layer model M3 includes a projecting part M3T projecting outward beyond the side surface MIS of the middle layer model M1. Specifically, the second surface layer model M3 is a metal member configured to have a portion projecting beyond a resin member, unlike the construction including the above-described outer terminal 6.

FIG. 4 is a diagram showing stress distribution obtained from the CAE analysis using the analysis model M shown in FIG. 3. FIG. 4 illustrates a stress distribution in the middle layer model M1 when the temperature of the analysis model M is changed. The metal member and the resin member expand and contract according to temperature changes with different expansion and contraction degrees. Therefore, due to the difference in expansion and contraction degree between the metal and resin members, stress acts on the middle layer model M1 which is the resin member.

The stress distribution is shown with the density of dots or oblique lines in FIG. 4. Higher density of dots or oblique lines indicates higher stress. Relatively low stress regions are indicated by dots. Higher stress regions than the dotted ranges are indicated by oblique lines. In other words, a region H indicated by oblique lines is the area where high stress was observed.

FIG. 4 shows that, on the side surface M1S of the middle layer model M1, the region His biased toward the side closer to the second principal surface M1B than the side closer to the first principal surface M1A. The second principal surface M1B is the plane joined to the second surface layer model M3 having the projecting part M3T that projects laterally outward beyond the side surface M1S of the middle layer model M1. It is confirmed from the above that, for the resin member with its front and back surfaces joined to the metal members, one of the metal members having a portion projecting beyond the side surface of the resin member, high stress tends to concentrate and act on or near the joining surface of the resin member joined to the metal member with the projecting portion. It has been further confirmed that, when the side surface of the metal member does not project outward beyond the side surface of the resin member, the stress acting on the resin member is lower as compared to when the side surface of the metal member projects beyond the side surface of the resin member.

In the embodiment, as described above, the side surface 57 of the protruding portion 55 of the lid member 5 and the side surface 34 of the terminal plate-shaped portion 32 of the terminal part 30 are configured not to project outward beyond the side surface 15 of the inner resin plate-shaped portion 13. In the battery 1 in the embodiment thus configured, even if temperature changes occur, a high stress is suppressed from acting on the inner resin plate-shaped portion 13. This suppresses resin member 10 from being damaged.

In actual, it is difficult to arrange both the side surface 57 of the protruding portion 55 of the lid member 5 and the side surface 34 of the terminal plate-shaped portion 32 of the terminal part 30 on the same plane as, i.e., flush with, the side surface 16 of the inner resin plate-shaped portion 13. Therefore, the side surface 16 of the inner resin plate-shaped portion 13 may be formed projecting beyond at least one of the side surface 57 of the protruding portion 55 of the lid member 5 and the side surface 34 of the terminal plate-shaped portion 32 of the terminal part 30. This configuration can reliably suppress the action of high stress on the inner resin plate-shaped portion 13 on the side joined to the one metal member. This can more reliably suppress damage to the resin member 10. As an alternative, the side surface 16 of the inner resin plate-shaped portion 13 may be configured to project beyond both the side surface 57 of the protruding portion 55 of the lid member 5 and the side surface 34 of the terminal plate-shaped portion 32 of the terminal part 30. This configuration can further suppress high stress from acting on the entire inner resin plate-shaped portion 13. This can further suppress damage to the resin member 10.

The resin member 10 is made of base resin mixed with filler. The filler contained in the inner resin plate-shaped portion 13 may be mainly oriented in a direction parallel to the joining surface of the inner resin plate-shaped portion 13 joined to the metal member. In the embodiment, the main orientation direction of the filler in the inner resin plate-shaped portion 13 is parallel to the protruding inner surface 52A of the protruding portion 55 of the lid member 5 and the first principal surface 35 of the terminal plate-shaped portion 32 of the terminal part 30.

In general, the resin member containing the filler tends to have higher mechanical strength in the filler orientation direction than in the direction perpendicular to this filler orientation direction. In the resin member, when temperature changes occur, the tensile force by the metal member acts on or near the joining surface joined to the metal member having a different linear expansion coefficient from the resin member. The direction of this force is generally parallel to the joining surface of the resin member joined to the metal member. Since the main orientation direction of the filler in the inner resin plate-shaped portion 13 is parallel to the joining surface of the inner resin plate-shaped portion 13 to the metal member, the resin member 10 can be prevented from damage.

Specifically, the average orientation direction of the filler contained in the inner resin plate-shaped portion 13 may be at an angle of 20° or less with respect to the surface of the metal member joined to the inner resin plate-shaped portion 13. This configuration can reduce the stress acting on the inner resin plate-shaped portion 13 due to temperature changes to the level that can appropriately suppress damage to the inner resin plate-shaped portion 13. In the embodiment, the protruding inner surface 52A of the protruding portion 55 of the lid member 5 is parallel to the first principal surface 35 of the terminal plate-shaped portion 32 of the terminal part 30. This means that the angle of the average orientation direction of the filler contained in the inner resin plate-shaped portion 13 with respect to the protruding inner surface 52A of the protruding portion 55 of the lid member 5 is the same as the angle of the average orientation direction of the filler contained in the inner resin plate-shaped portion 13 with respect to the first principal surface 35 of the terminal plate-shaped portion 32 of the terminal part 30.

Even when the protruding inner surface 52A of the protruding portion 55 of the lid member 5 is not parallel to the first principal surface 35 of the terminal plate-shaped portion 32 of the terminal part 30, the average orientation direction of the filler in the inner resin plate-shaped portion 13 may be at an angle of 20° or less with respect to each of the protruding inner surface 52A and the first principal surface 35. As for the angle of the average orientation direction of the filler contained in the inner resin plate-shaped portion 13 to the surface of the metal member joined to the inner resin plate-shaped portion 13, the smaller tends to be more desirable. Accordingly, the angle of the average orientation direction of the filler contained in the inner resin plate-shaped portion 13 to the surface of the metal member joined to the inner resin plate-shaped portion 13 may further be set to an angle of 15° or less.

In the embodiment, the angle between the average orientation direction of the filler in the inner resin plate-shaped portion 13 and the surface of the metal member joined to the inner resin plate-shaped portion 13 can be obtained using computed tomography (CT) images. Specifically, based on a CT image obtained for the cross-section perpendicular to the surface of the metal member joined to the inner resin plate-shaped portion 13, the angle is obtained by calculating multiple angles of the filler in the longitudinal direction to the surface reference line of the metal member and averaging the multiple angles. The surface reference line of the metal member on the CT image can be an average line of any five points extracted from the surface of the metal member.

Further, the surface of the metal member to be joined to the resin member 10 may be formed as an uneven surface with fine asperities (e.g., micro/nano asperities) so that the resin member 10 penetrates, or bites, into the asperities to form a fine anchor structure. The fine asperities can be formed by irradiating the surface of the metal member with a laser, thereby roughening the surface. In the area where the anchor structure is formed, the joining strength between the resin member 10 and the metal member can be enhanced. This can suppress separation of the resin member 10 from the metal member.

The asperities described above may be formed in at least a part of the protruding inner surface 52A of the protruding portion 55 of the lid member 5, which faces the inner resin plate-shaped portion 13. This configuration can suppress the inner resin plate-shaped portion 13 from separating from the protruding portion 55 of the lid member 5. Further, the asperities may be formed in at least a part of the first principal surface 35 of the terminal plate-shaped portion 32 of the terminal part 30, which faces the inner resin plate-shaped portion 13. This configuration can suppress the inner resin plate-shaped portion 13 from separating from the terminal plate-shaped portion 32. Moreover, the asperities may be formed in both of the protruding inner surface 52A of the protruding portion 55 of the lid member 5 and the first principal surface 35 of the terminal plate-shaped portion 32. This configuration can suppress both defects; separation of the inner resin plate-shaped portion 13 from the protruding portion 55 and separation of the inner resin plate-shaped portion 13 from the first principal surface 35 of the terminal plate-shaped portion 32.

Even when the joining strength between the inner resin plate-shaped portion 13 and the metal member is high, the above-described configuration in the embodiment can suppress high stress from acting on the inner resin plate-shaped portion 13 when the temperature changes. Thus, the inner resin plate-shaped portion 13 is suppressed from being damaged. In other words, when the temperature changes, both of separation of the inner resin plate-shaped portion 13 and damages to the inner resin plate-shaped portion 13 are suppressed.

As described in detail above, the battery 1 in the embodiment includes the battery case 2, the terminal part 30, and the resin member 10. The battery case 2 includes the lid member 5 formed with the through hole 53. The terminal part 30 is provided extending to the inside and outside of the battery case 2 through the through hole 53. The resin member 10 is provided between the lid member 5 of the battery case 2 and the terminal part 30. The resin member 10 is joined to the lid member 5 and the terminal part 30. Further, the terminal part 30 includes the columnar portion 31 and the terminal plate-shaped portion 32. The columnar portion 31 is positioned so that at least a part thereof is located inside the through hole 53. The terminal plate-shaped portion 32 is located inside the battery case 2 and has a shape extended outwardly larger than the through hole 53 along the inner surface 52 of the lid member 5. The resin member 10 includes the tube-shaped portion 11 and the inner resin plate-shaped portion 13. The tube-shaped portion 11 is located between the wall surface 54 of the through hole 53 and the columnar portion 31. The inner resin plate-shaped portion 13 is located between the inner surface 52 of the lid member 5 and the terminal plate-shaped portion 32. Along the circumferential edge of the through hole 53 on the inner surface 52 side of the lid member 5, the protruding inner surface 52A joined to the inner resin plate-shaped portion 13 protrudes toward the inside of the battery case 2 as compared with the non-protruding inner surface 52B, that is farther from the through hole 53 than the protruding inner surface 52A, forming the protruding portion 55. Both of the side surface 57 of the protruding portion 55 and the side surface 34 of the terminal plate-shaped portion 32 do not project outward beyond the side surface 16 of the inner resin plate-shaped portion 13. This configuration can suppress the stress from acting on the inner resin plate-shaped portion 13 due to temperature changes. Thus, the battery 1 with the resin member 10 that is less likely to be damaged is achieved.

The foregoing embodiments and examples are mere illustrative and give no limitation to the present disclosure in any way. The disclosure may be variously embodied and modified without departing from the essential characteristics thereof.

For instance, the region where the fine anchor structure is formed may be adjusted as needed. Specifically, fine asperities may be formed in all the regions of the surfaces of the lid member 5 and the terminal part 30, which are to be joined to the resin member 10. As another variant, the fine asperities may be formed over the entire surface of at least one of the protruding inner surface 52A of the protruding portion 55 and the first principal surface 35 of the terminal plate-shaped portion 32. As still another variant, when the fine asperities are formed in at least a partial region of each of the protruding inner surface 52A of the protruding portion 55 and the first principal surface 35 of the terminal plate-shaped portion 32, the region to be formed with the asperities may be a continuous area surrounding the through hole 53. This is because the battery case 2 thus configured can maintain a high degree of sealing property.

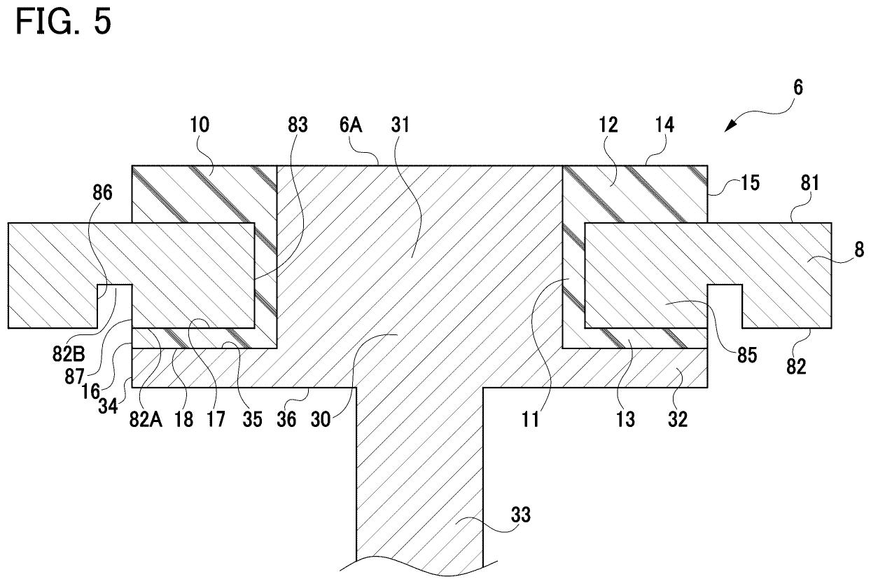

As another variant, as long as the side surface 57 of the protruding portion 55 is provided surrounding the opening of the through hole 53 on the inner surface 52 side of the lid member 5, the far portion of the lid member 5, that is farther from the through hole 53 than the protruding portion 55, may be configured in any shapes. Specifically, for example, a lid member 8 shown in FIG. 5 may be employed. This lid member 8 is formed with a through hole 83 penetrating from an outer surface 81 to an inner surface 82 and formed, on the inner surface 82 side, with a continuous ring-shaped groove 86 surrounding the opening of the through hole 83. Accordingly, a protruding portion 85 is provided inside the groove 86, that is, on the side closer to the through hole 83 relative to the groove 86. A protruding inner surface 82A of the protruding portion 85 is joined to the inner resin plate-shaped portion 13 of the resin member 10. Moreover, even in the lid member 8 of the above shape, the protruding inner surface 82A also protrudes toward the inside of the battery case 2 as compared with a bottom surface 82B of the groove 86, that is farther from the through hole 83 than the protruding inner surface 82A. Even when the lid member 8 is employed, a side surface 87 of the protruding portion 85 has only to be configured without projecting outward beyond the side surface 16 of the inner resin plate-shaped portion 13.

As another variant, the outer terminal 6 may be provided in the casing 4 of the battery case 2. As still another variant, the terminal part 30 may be constituted of a single part or two or more parts connected together. Each part of the construction including the outer terminal 6 has a rectangular cross-section perpendicular to the axial direction of the through hole 83, but it is not limited to the rectangular shape; for example it may have a circular cross-section.

Although the detailed configuration including the outer terminal 6 for a positive electrode is described above, a configuration including the outer terminal 7 for a negative electrode may also be similar. The configuration including the negative outer terminal 7 may be made of different materials from the configuration including the positive outer terminal 6 as needed. For example, in the configuration including the outer terminal 7, a terminal part connected to the negative electrode plate 3B on the inside of the battery case 2 may be made of copper. Furthermore, the disclosure may be applied to only one of the configuration including the positive outer terminal 6 or the negative outer terminal 7.

Moreover, the above-described disclosure includes the following configurations.

### First Configuration

A battery comprises: a battery case formed with a through hole; a terminal part provided extending through the through hole to inside and outside of the battery case; and a resin member provided between and joined to the battery case and the terminal part, wherein the terminal part includes a columnar portion, at least a part of which is located in the through hole, and a terminal plate-shaped portion that is located in the battery case and has a shape extending more widely than the through hole along an inner surface of the battery case, the resin member includes a tube-shaped portion located between a wall surface of the through hole and the columnar portion of the terminal part, and a resin plate-shaped portion located between the inner surface of the battery case and the terminal plate-shaped portion, the battery case includes a protruding portion, on the inner surface along a circumferential edge of the through hole, the protruding portion including a joining inner surface that is joined to the resin plate-shaped portion and located protruding toward the inside of the battery case as compared with a portion of the inner surface, that is farther from the through hole than the joining inner surface, and the protruding portion and the terminal plate-shaped portion each have a side surface that does not project outward beyond a side surface of the resin plate-shaped portion.

### Second Configuration

In the foregoing first configuration, the side surface of the resin plate-shaped portion projects beyond at least one of the side surface of the protruding portion and the side surface of the terminal plate-shaped portion.

### Third Configuration

In the foregoing first or second configuration, the resin member is made of base resin containing filler, and the filler in the resin plate-shaped portion is mainly oriented in an orientation direction parallel to the joining inner surface of the battery case and a joining surface of the terminal plate-shaped portion joined to the resin plate-shaped portion.

### Fourth Configuration

In any one of the foregoing first to third configuration, at least one of the protruding portion of the battery case and the terminal plate-shaped portion of the terminal part includes a region that faces the resin plate-shaped portion and is formed with fine asperities, and the resin member penetrates into the asperities to form an anchor structure.

### REFERENCE SIGNS LIST

1 Battery
2 Battery case
5, 8 Lid member
10 Resin member
11 Tube-shaped portion
13 Inner resin plate-shaped portion
16 Side surface
30 Terminal part
31 Columnar portion
32 Terminal plate-shaped portion
34 Side surface
52, 82 Inner surface
52A, 82A Protruding inner surface (Joining inner surface)
52B Non-protruding inner surface
82B Bottom surface
53, 83 Through hole
54 Wall surface
55, 85 Protruding portion
57, 87 Side surface

What is claimed is:

1. A battery comprising:
a battery case formed with a through hole;
a terminal part provided extending through the through hole to inside and outside of the battery case; and
a resin member provided between and joined to the battery case and the terminal part,
wherein the terminal part includes a columnar portion, at least a part of which is located in the through hole, and a terminal plate-shaped portion that is located in the battery case and has a shape extending more widely than the through hole along an inner surface of the battery case,
the resin member includes a tube-shaped portion located between a wall surface of the through hole and the columnar portion of the terminal part, and a resin plate-shaped portion located between the inner surface of the battery case and the terminal plate-shaped portion,
the battery case includes a protruding portion, on the inner surface along a circumferential edge of the through hole, the protruding portion including a joining inner surface that is joined to the resin plate-shaped portion and located protruding toward the inside of the battery case as compared with a portion of the inner surface, that is farther from the through hole than the joining inner surface, and
the protruding portion and the terminal plate-shaped portion each have a side surface that does not project outward beyond a side surface of the resin plate-shaped portion.

2. The battery according to claim 1, wherein the side surface of the resin plate-shaped portion projects beyond at least one of the side surface of the protruding portion and the side surface of the terminal plate-shaped portion.

3. The battery according to claim 1, wherein
the resin member is made of base resin containing filler, and
the filler in the resin plate-shaped portion is mainly oriented in an orientation direction parallel to the joining inner surface of the battery case and a joining surface of the terminal plate-shaped portion joined to the resin plate-shaped portion.

4. The battery according to claim 2, wherein
the resin member is made of base resin containing filler, and
the filler in the resin plate-shaped portion is mainly oriented in an orientation direction parallel to the joining inner surface of the battery case and a joining surface of the terminal plate-shaped portion joined to the resin plate-shaped portion.

5. The battery according to claim 1, wherein
at least one of the protruding portion of the battery case and the terminal plate-shaped portion of the terminal part includes a region that faces the resin plate-shaped portion and is formed with fine asperities, and
the resin member penetrates into the asperities to form an anchor structure.

6. The battery according to claim 2, wherein
at least one of the protruding portion of the battery case and the terminal plate-shaped portion of the terminal part includes a region that faces the resin plate-shaped portion and is formed with fine asperities, and
the resin member penetrates into the asperities to form an anchor structure.

7. The battery according to claim 3, wherein
at least one of the protruding portion of the battery case and the terminal plate-shaped portion of the terminal part includes a region that faces the resin plate-shaped portion and is formed with fine asperities, and
the resin member penetrates into the asperities to form an anchor structure.

8. The battery according to claim 4, wherein
at least one of the protruding portion of the battery case and the terminal plate-shaped portion of the terminal part includes a region that faces the resin plate-shaped portion and is formed with fine asperities, and
the resin member penetrates into the asperities to form an anchor structure.
